(19) United States
(12) Patent Application Publication
(10) Pub. No.: US 2011/0115771 A1
(43) Pub. Date: May 19, 2011

(54) LIQUID CRYSTAL DISPLAY AND METHOD OF DRIVING THE SAME

(76) Inventors: Jing-Teng Cheng, Hsin-Chu (TW); Chao-Ching Hsu, Hsin-Chu (TW)

(21) Appl. No.: 12/778,121

(22) Filed: May 12, 2010

(30) Foreign Application Priority Data
Nov. 19, 2009 (TW) 098139346

(51) Int. Cl. G06F 3/038; G09G 3/36

(52) U.S. Cl. 345/211; 345/87

(57) ABSTRACT

A liquid crystal display includes a reference voltage generator, a voltage selector, a timing controller, a voltage level shifter, a gate driving circuit and a pixel array. The reference voltage generator is employed to provide a first high reference voltage and a second high reference voltage. The voltage selector is utilized for selecting either the first high reference voltage or the second high reference voltage as a high reference voltage. The timing controller functions to provide a scan control signal. The voltage level shifter generates a preliminary driving signal according to the scan control signal and the high reference voltages. The gate driving circuit provides plural gate signals according to the preliminary driving signal. The pixel array is for displaying images according to the gate signals.

### BACKGROUND OF THE INVENTION

1. Field of the Invention

The present invention relates to a liquid crystal display and a method of driving the same, and more particularly, to a liquid crystal display capable of adjusting a reference voltage and a method of driving the same.

2. Description of the Prior Art

Along with the advantages of thin appearance, low power consumption, and low radiation, liquid crystal displays (LCDs) have been widely applied in various electronic products for panel displaying. The operation of a liquid crystal display is featured by varying voltage drops between opposite sides of a liquid crystal layer for twisting the angles of the liquid crystal molecules in the liquid crystal layer so that the transmittance of the liquid crystal layer can be controlled for illustrating images with the aid of light source provided by a backlight module or ambient light. FIG. 1 is a schematic diagram showing a prior-art liquid crystal display. As shown in FIG. 1, the liquid crystal display 100 comprises a reference voltage generator 110, a timing controller 140, a voltage level shifter 150, a source driving circuit 160, a gate driving circuit 170 and a pixel array unit 180. The reference voltage generator 110 is employed to provide a high reference voltage Vgh and a low reference voltage Vgl. The timing controller 140 functions to provide a scan control signal Sx required for the operation of the gate driving circuit 170.

The voltage level shifter 150 is utilized for generating a preliminary driving signal Si according to the scan control signal Sx, the high reference voltage Vgh and the low reference voltage Vgl. The preliminary driving signal Si may comprise a start pulse signal Vst, a first clock signal Vck1, and a second clock signal Vck2 having a phase opposite to the first clock signal Vck1. The gate driving circuit 170 provides plural gate signals according to the preliminary driving signal Si received from the voltage level shifter 150. The source driving circuit 160 is employed to provide plural data signals. And the pixel array unit 180 is utilized for displaying images based on the data signals which are written into plural pixels PX under control of the gate signals. Regarding the design of the liquid crystal display 100, in order to bring the cost down, the integration of the gate driving circuit 170 into a display panel 185 comprising the pixel array unit 180, i.e. based on the architecture of Gate-driver On Array (GOA), has gained popularity. The gate driving circuit 170 includes a plurality of shift register stages SR1˜SRn electrically connected to plural gate lines 175 respectively. And therefore, in the GOA architecture, the shift register stages SR1˜SRn are sequentially disposed in a lengthy border area, i.e. not integrated in a tiny chip area.

In view of that, the high-level voltage of the gate signal generated by the last shift register stage SRn is likely to be significantly lower than that of the gate signal generated by the first shift register stage SR1. And therefore the gate signal generated by the last shift register stage SRn may be unable to provide an accurate control of writing the data signals into corresponding pixels PX. In general, the voltage reduction phenomenon occurring to the high-level voltage of the gate signal is prone to be serious regarding the operation of last few shift register stages. Besides, the aforementioned voltage reduction phenomenon is worse while initially powering the liquid crystal display 100. In addition, because the turn-on speed of thin film transistors becomes lower following a decrease of temperature, the aforementioned voltage reduction phenomenon is even worse while initially powering the liquid crystal display 100 at low temperature. In other words, the pixel array unit 180 is unlikely to function properly immediately after powering the liquid crystal display 100 at low temperature.

### SUMMARY OF THE INVENTION

In accordance with one embodiment of the present invention, a liquid crystal display capable of adjusting a reference voltage is provided. The liquid crystal display comprises a reference voltage generator, a voltage selector, a control unit, a timing controller, a voltage level shifter, a gate driving circuit, and a pixel array unit. The reference voltage generator is employed to provide a first high reference voltage and a second high reference voltage less than the first high reference voltage. The voltage selector, electrically connected to the reference voltage generator for receiving the first and second high reference voltages, is utilized for selecting either the first high reference voltage or the second high reference voltage as a high reference voltage according to a control signal. The control unit, electrically connected to the voltage selector, is employed to provide the control signal. The timing controller is employed to provide a scan control signal. The voltage level shifter, electrically connected to the timing controller and the voltage selector, is utilized for generating a preliminary driving signal according to the scan control signal and the high reference voltage. The gate driving circuit, electrically connected to the voltage level shifter, is utilized for providing a plurality of gate signals according to the preliminary driving signal. The pixel array unit, electrically connected to gate driving circuit, is for displaying images according to the gate signals. In the operation of the liquid crystal display, the high reference voltage is changed from the first high reference voltage to the second high reference voltage when a predetermined time has elapsed since initially powering the liquid crystal display.

In accordance with another embodiment of the present invention, a liquid crystal display capable of adjusting a reference voltage is provided. The liquid crystal display comprises a reference voltage generator, an adjustable power module, a timing controller, a voltage level shifter, a gate driving circuit, and a pixel array unit. The reference voltage generator is employed to provide a high reference voltage and a low reference voltage based on a power voltage. The adjustable power module, electrically connected to the reference voltage generator, is employed to provide the power voltage. The power voltage provided by the adjustable power module is changed from a first voltage to a second voltage less than the first voltage when a predetermined time has elapsed since initially powering the liquid crystal display. The timing controller is employed to provide a scan control signal. The voltage level shifter, electrically connected to the timing controller and the reference voltage generator, is utilized for generating a preliminary driving signal according to the scan control signal, the high reference voltage and the low reference voltage. The gate driving circuit, electrically connected to the voltage level shifter, is utilized for providing a plurality of gate signals according to the preliminary driving signal. The pixel array unit, electrically connected to gate driving circuit, is for displaying images according to the gate signals.

The present invention further provides a method of driving a liquid crystal display. The method comprises: providing a high reference voltage and a low reference voltage during a predetermined time after initially powering the liquid crystal display, wherein the high reference voltage is a first high reference voltage; driving a pixel array unit of the liquid crystal display for displaying images according to the first high reference voltage and the low reference voltage during the predetermined time; changing the high reference voltage from the first high reference voltage to a second high reference voltage less than the first high reference voltage after the predetermined time; and driving the pixel array unit for displaying images according to the second high reference voltage and the low reference voltage after the predetermined time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a prior-art liquid crystal display.

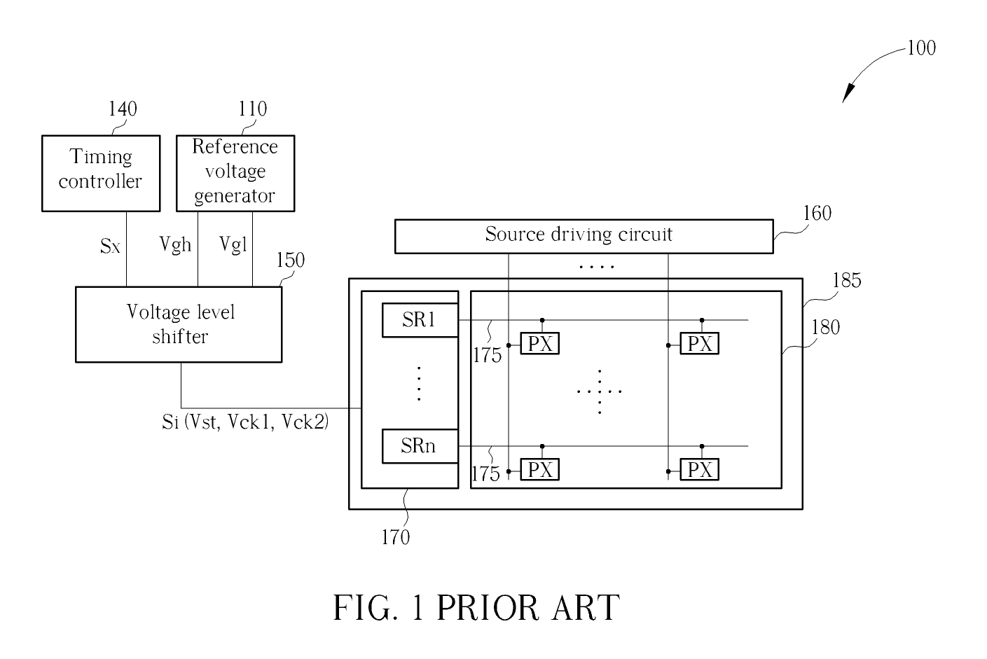

FIG. 2 is a structural diagram schematically showing a liquid crystal display in accordance with a first embodiment of the present invention.

FIG. 3 is a structural diagram schematically showing a liquid crystal display in accordance with a second embodiment of the present invention.

FIG. 4 is a structural diagram schematically showing a liquid crystal display in accordance with a third embodiment of the present invention.

FIG. 5 is a structural diagram schematically showing a liquid crystal display in accordance with a fourth embodiment of the present invention.

FIG. 6 is a flowchart depicting a method of driving a liquid crystal display in accordance with an embodiment of the present invention.

### DETAILED DESCRIPTION

Hereinafter, preferred embodiments of the present invention will be described in detail with reference to the accompanying drawings. Here, it is to be noted that the present invention is not limited thereto. Furthermore, the step serial numbers regarding the method of driving a liquid crystal display are not meant thereto limit the operating sequence, and any rearrangement of the operating sequence for achieving same functionality is still within the spirit and scope of the invention.

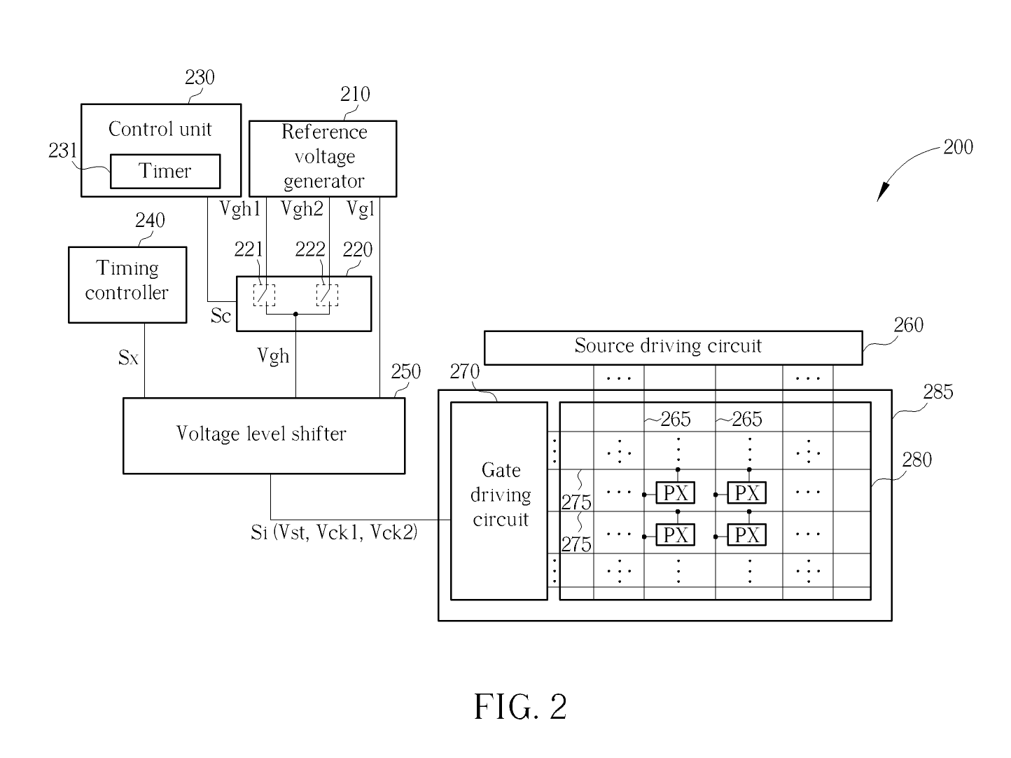

FIG. 2 is a structural diagram schematically showing a liquid crystal display in accordance with a first embodiment of the present invention. As shown in FIG. 2, the liquid crystal display 200 comprises a reference voltage generator 210, a voltage selector 220, a control unit 230, a timing controller 240, a voltage level shifter 250, a source driving circuit 260, a gate driving circuit 270 and a pixel array unit 280. The pixel array unit 280 comprises plural pixels PX which are electrically connected to the source driving circuit 260 via plural data lines 265 and are electrically connected to the gate driving circuit 270 via plural gate lines 275. The gate driving circuit 270 can be integrated into a display panel 285 comprising the pixel array unit 280.

The reference voltage generator 210 is employed to provide a first high reference voltage Vgh1, a second high reference voltage Vgh2 lower than the first high reference voltage Vgh1, and a low reference voltage Vgl. The voltage selector 220 is electrically connected to the reference voltage generator 210 for receiving the first high reference voltage Vgh1 and the second high reference voltage Vgh2. The voltage selector 220 selects either the first high reference voltage Vgh1 or the second high reference voltage Vgh2 as a high reference voltage Vgh according to a control signal Sc. The control unit 230, electrically connected to the voltage selector 220, is employed to provide the control signal Sc. In the operation of the liquid crystal display 200, the voltage selector 220 changes the high reference voltage Vgh from the first high reference voltage Vgh1 to the second high reference voltage Vgh2 according to the control signal Sc when a predetermined time has elapsed since initially powering the liquid crystal display 200.

The timing controller 240 is adapted to provide a scan control signal Sx required for the operation of the gate driving circuit 270. The voltage level shifter 250, electrically connected to the timing controller 240, the voltage selector 220 and the reference voltage generator 210, is utilized for generating a preliminary driving signal Si according to the scan control signal Sx, the high reference voltage Vgh and the low reference voltage Vgl. The preliminary driving signal Si may comprise a start pulse signal Vst, a first clock signal Vck1, and a second clock signal Vck2 having a phase opposite to the first clock signal Vck1. And the gate driving circuit 270 is employed to generate plural gate signals for scanning the gate lines 275 according to the preliminary driving signal Si. The source driving circuit 260 is utilized for providing plural data signals furnished to the pixel array unit 280 via the data lines 265. The pixel array unit 280 is for displaying images based on the data signals which are written into the pixels PX under control of the gate signals.

In the embodiment shown in FIG. 2, the voltage selector 220 comprises a first switch 221 and a second switch 222, and the control unit 230 comprises a timer 231. The first switch 221, electrically connected to the control unit 230, the reference voltage generator 210 and the voltage level shifter 250, is for outputting the first high reference voltage Vgh1 to become the high reference voltage Vgh according to the control signal Sc. The second switch 222, electrically connected to the control unit 230, the reference voltage generator 210 and the voltage level shifter 250, is for outputting the second high reference voltage Vgh2 to become the high reference voltage Vgh according to the control signal Sc. In the operation of the liquid crystal display 200, when the control signal Sc holds a first state, the second switch 222 is turned off (opened) and the first switch 221 is turned on (closed), for outputting the first high reference voltage Vgh1 to become the high reference voltage Vgh. Alternatively, when the control signal Sc holds a second state, the first switch 221 is turned off and the second switch 222 is turned on, for outputting the second high reference voltage Vgh2 to become the high reference voltage Vgh. The timer 231 is employed to generate a timing signal through performing a timing operation automatically after the liquid crystal display 200 is powered. And the control unit 230 provides the control signal Sc according to the timing signal.

In summary, when the predetermined time has elapsed since initially powering the liquid crystal display 200, the control unit 230 switches the control signal Sc from the first state to the second state according to the timing signal. Accordingly, the first switch 221 is switched from turn-on state to turn-off state and the second switch 222 is switched from turn-off state to turn-on state so that the high reference voltage Vgh is changed from the first high reference voltage Vgh1 to the second high reference voltage Vgh2. That is, after initially powering the liquid crystal display 200, the voltage selector 220 first selects the first high reference voltage Vgh1 as the high reference voltage Vgh in order that the pixel array unit 280 is able to function properly for displaying high-quality images immediately after powering the liquid crystal display 200. And when the predetermined time has elapsed since initially powering the liquid crystal display 200, the voltage selector 220 selects the second high reference voltage Vgh2 as the high reference voltage Vgh for saving power consumption. In addition, if the first high reference voltage Vgh1 is set to be adaptive for use at low ambient temperature, the pixel array unit 280 is capable of working properly to display high-quality images immediately after powering the liquid crystal display 200 at low ambient temperature.

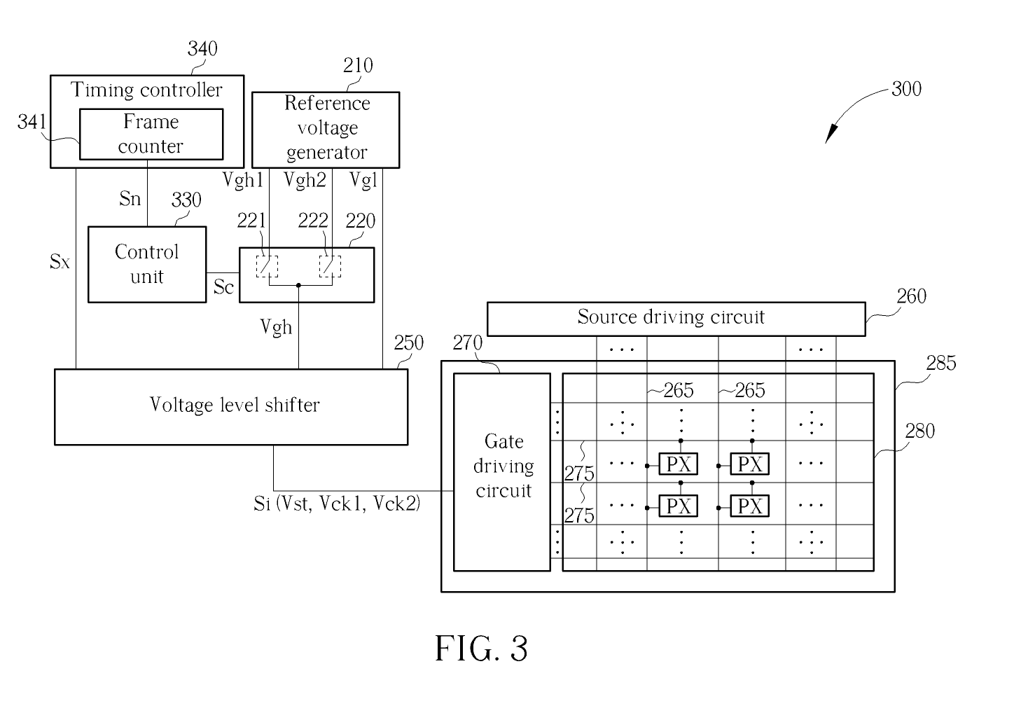

FIG. 3 is a structural diagram schematically showing a liquid crystal display in accordance with a second embodiment of the present invention. As shown in FIG. 3, the structure of the liquid crystal display 300 is similar to that of the liquid crystal display 200 shown in FIG. 2, differing in that the control unit 230 is replaced with a control unit 330 and the timing controller 240 is replaced with a timing controller 340. The timing controller 340 comprises a frame counter 341 electrically connected to the control unit 330. The frame counter 341 is utilized for generating a counting signal Sn through performing a frame counting operation automatically after the liquid crystal display 300 is powered. The control unit 330 provides the control signal Sc to the voltage selector 220 according to the counting signal Sn. When a predetermined number of frames have been displayed since initially powering the liquid crystal display 300, the control unit 330 switches the control signal Sc from the first state to the second state according to the counting signal Sn. Accordingly, the first switch 221 is switched from turn-on state to turn-off state and the second switch 222 is switched from turn-off state to turn-on state so that the high reference voltage Vgh is changed from the first high reference voltage Vgh1 to the second high reference voltage Vgh2. The period required for displaying the predetermined number of frames is substantially identically to the aforementioned predetermined time in the operation of the liquid crystal display 200. The other functional operations of the liquid crystal display 300 are identical to the corresponding operations of the liquid crystal display 200. That is, the pixel array unit 280 is still able to function properly for displaying high-quality images immediately after powering the liquid crystal display 300 even if the ambient temperature is low.

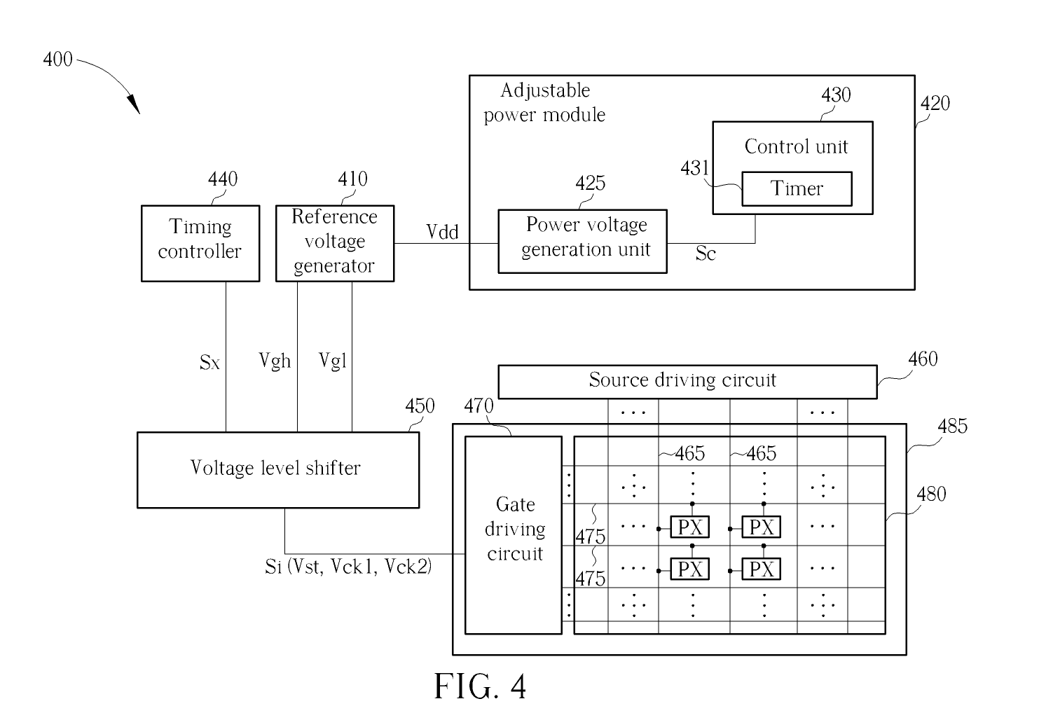

FIG. 4 is a structural diagram schematically showing a liquid crystal display in accordance with a third embodiment of the present invention. As shown in FIG. 4, the liquid crystal display 400 comprises a reference voltage generator 410, an adjustable power module 420, a timing controller 440, a voltage level shifter 450, a source driving circuit 460, a gate driving circuit 470 and a pixel array unit 480. The pixel array unit 480 comprises plural pixels PX which are electrically connected to the source driving circuit 460 via plural data lines 465 and are electrically connected to the gate driving circuit 470 via plural gate lines 475. The gate driving circuit 470 can be integrated into a display panel 485 comprising the pixel array unit 480.

The adjustable power module 420 is utilized for providing a power voltage Vdd to the reference voltage generator 410. The reference voltage generator 410, electrically connected to the adjustable power module 420, is employed to provide a high reference voltage Vgh and a low reference voltage Vgl based on the power voltage Vdd. In the operation of the liquid crystal display 400, the adjustable power module 420 changes the power voltage Vdd from a first voltage to a second voltage less than the first voltage when a predetermined time has elapsed since initially powering the liquid crystal display 400. Accordingly, the high reference voltage Vgh provided by the reference voltage generator 410 is changed from a first high reference voltage to a second high reference voltage less than the first high reference voltage following the aforementioned change of the power voltage Vdd.

The timing controller 440 functions to provide a scan control signal Sx required for the operation of the gate driving circuit 470. The voltage level shifter 450, electrically connected to the timing controller 440 and the reference voltage generator 410, is utilized for generating a preliminary driving signal Si according to the scan control signal Sx, the high reference voltage Vgh and the low reference voltage Vgl. The preliminary driving signal Si may comprise a start pulse signal Vst, a first clock signal Vck1, and a second clock signal Vck2 having a phase opposite to the first clock signal Vck1. And the gate driving circuit 470 is employed to generate plural gate signals for scanning the gate lines 475 according to the preliminary driving signal Si. The source driving circuit 460 is utilized for providing plural data signals furnished to the pixel array unit 480 via the data lines 465. The pixel array unit 480 is for displaying images based on the data signals which are written into the pixels PX under control of the gate signals.

In the embodiment shown in FIG. 4, the adjustable power module 420 comprises a control unit 430 and a power voltage generation unit 425. The control unit 430 is employed to provide a control signal Sc. The power voltage generation unit 425, electrically connected to the control unit 430 and the reference voltage generator 410, is utilized for generating the power voltage Vdd according to the control signal Sc. In the operation of the liquid crystal display 400, when the control unit 430 provides the control signal Sc having a first state, the power voltage Vdd generated by the power voltage generation unit 425 is the first voltage so that the high reference voltage Vgh provided by the reference voltage generator 425 becomes the first high reference voltage. Alternatively, when the control unit 430 provides the control signal Sc having a second state, the power voltage Vdd generated by the power voltage generation unit 425 is the second voltage so that the high reference voltage Vgh provided by the reference voltage generator 425 becomes the second high reference voltage. The control unit 430 comprises a timer 431. The timer 431 is employed to generate a timing signal through performing a timing operation automatically after the liquid crystal display 400 is powered. And the control unit 430 provides the control signal Sc according to the timing signal.

In summary, when the predetermined time has elapsed since initially powering the liquid crystal display 400, the control unit 430 switches the control signal Sc from the first state to the second state according to the timing signal. Accordingly, the power voltage Vdd is changed from the first voltage to the second voltage so that the high reference voltage Vgh is changed from the first high reference voltage to the second high reference voltage. That is, after initially powering the liquid crystal display 400, the reference voltage generator 410 first provides the first high reference voltage as the high reference voltage Vgh in order that the pixel array unit 480 is able to function properly for displaying high-quality images immediately after powering the liquid crystal display 400. And when the predetermined time has elapsed since initially powering the liquid crystal display 400, the reference voltage generator 410 provides the second high reference voltage as the high reference voltage Vgh for saving power consumption. In addition, if the first high reference voltage is set to be adaptive for use at low ambient temperature, the pixel array unit 480 is capable of working properly to display high-quality images immediately after powering the liquid crystal display 400 at low ambient temperature.

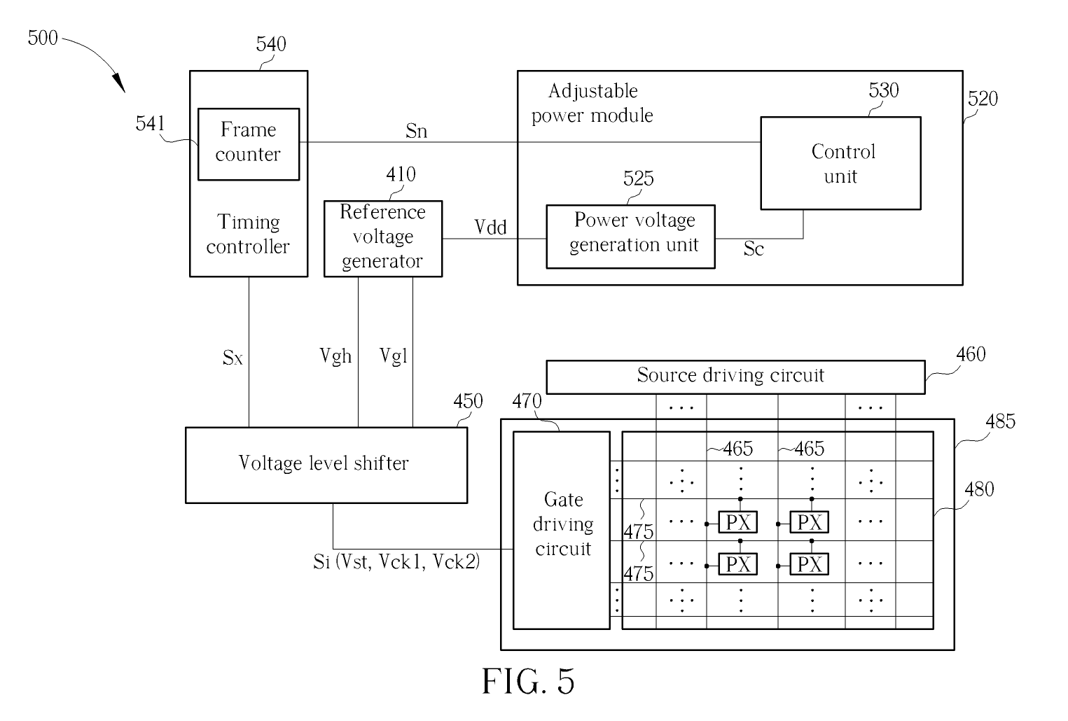

FIG. 5 is a structural diagram schematically showing a liquid crystal display in accordance with a fourth embodiment of the present invention. As shown in FIG. 5, the structure of the liquid crystal display 500 is similar to that of the liquid crystal display 400 shown in FIG. 4, differing in that the adjustable power module 420 is replaced with an adjustable power module 520 and the timing controller 440 is replaced with a timing controller 540. The adjustable power module 520 comprises a control unit 530 and a power voltage generation unit 525. The control unit 530 is employed to provide a control signal Sc. The power voltage generation unit 525, electrically connected to the control unit 530 and the reference voltage generator 410, is utilized for generating the power voltage Vdd according to the control signal Sc.

The timing controller 540 comprises a frame counter 541 electrically connected to the control unit 530. The frame counter 541 is utilized for generating a counting signal Sn through performing a frame counting operation automatically after the liquid crystal display 500 is powered. The control unit 530 provides the control signal Sc to the power voltage generation unit 525 according to the counting signal Sn. When a predetermined number of frames have been displayed since initially powering the liquid crystal display 500, the control unit 530 switches the control signal Sc from the first state to the second state according to the counting signal Sn. Accordingly, the power voltage Vdd is changed from the first voltage to the second voltage so that the high reference voltage Vgh is changed from the first high reference voltage to the second high reference voltage. The period required for displaying the predetermined number of frames is substantially identically to the aforementioned predetermined time in the operation of the liquid crystal display 400. The other functional operations of the liquid crystal display 500 are identical to the corresponding operations of the liquid crystal display 400. That is, the pixel array unit 480 is still able to function properly for displaying high-quality images immediately after powering the liquid crystal display 500 even if the ambient temperature is low.

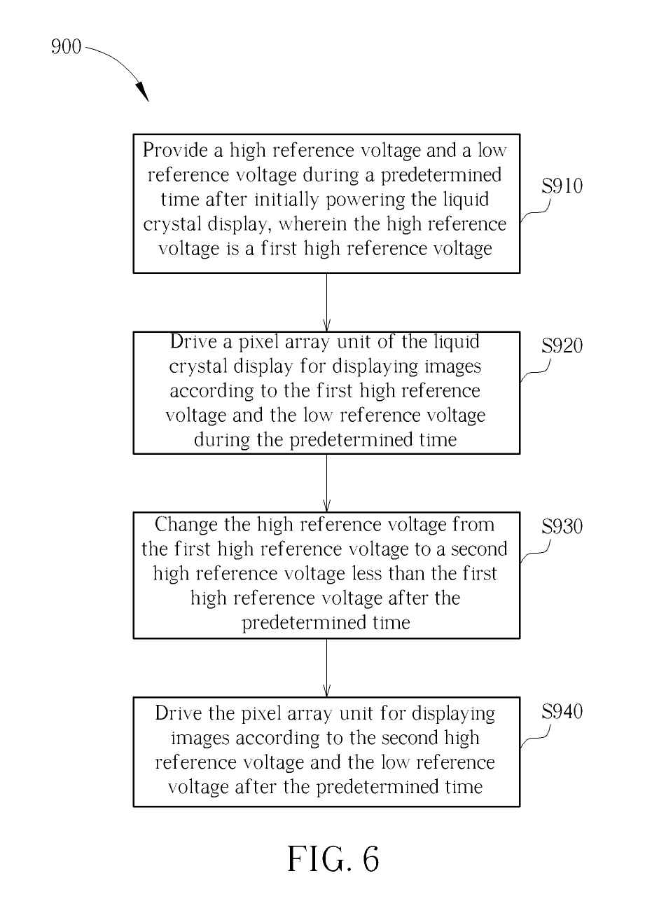

FIG. 6 is a flowchart depicting a method of driving a liquid crystal display in accordance with an embodiment of the present invention. The method regarding the flow 900 shown in FIG. 6 is implemented based on the liquid crystal display 200 in FIG. 2, the liquid crystal display 300 in FIG. 3, the liquid crystal display 400 in FIG. 4, or the liquid crystal display 500 in FIG. 5. The method illustrated in the flow 900 comprises the following steps:

Step S910: providing a high reference voltage and a low reference voltage during a predetermined time after initially powering the liquid crystal display, wherein the high reference voltage is a first high reference voltage;

Step S920: driving a pixel array unit of the liquid crystal display for displaying images according to the first high reference voltage and the low reference voltage during the predetermined time;

Step S930: changing the high reference voltage from the first high reference voltage to a second high reference voltage less than the first high reference voltage after the predetermined time; and

Step S940: driving the pixel array unit for displaying images according to the second high reference voltage and the low reference voltage after the predetermined time.

Regarding the method of driving the liquid crystal display 300 in FIG. 3 or the liquid crystal display 500 in FIG. 5, the aforementioned predetermined time in the flow 900 is a period required for displaying a predetermined number of frames. Regarding the method of driving the liquid crystal display 400 in FIG. 4 or the liquid crystal display 500 in FIG. 5, the step S930 of changing the high reference voltage from the first high reference voltage to the second high reference voltage less than the first high reference voltage is changing a power voltage from a first voltage to a second voltage less than the first voltage for changing the high reference voltage from the first high reference voltage to the second high reference voltage less than the first high reference voltage.

In conclusion, the liquid crystal display of the present invention performs driving operations with a first high reference voltage so as to display high-quality images immediately after powering the liquid crystal display. And when a predetermined time has elapsed since initially powering the liquid crystal display, the power consumption of the liquid crystal display can be reduced significantly by performing driving operations with a second high reference voltage less than the first high reference voltage. In addition, if the first high reference voltage is set to be adaptive for use at low ambient temperature, the liquid crystal display is capable of working properly to display high-quality images immediately after powering the liquid crystal display at low ambient temperature.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A liquid crystal display comprising:
a reference voltage generator for providing a first high reference voltage and a second high reference voltage less than the first high reference voltage;
a voltage selector, electrically connected to the reference voltage generator for receiving the first and second high reference voltages, for selecting either the first high reference voltage or the second high reference voltage as a high reference voltage according to a control signal;
a control unit, electrically connected to the voltage selector, for providing the control signal;
a timing controller for providing a scan control signal;
a voltage level shifter, electrically connected to the timing controller and the voltage selector, for generating a preliminary driving signal according to the scan control signal and the high reference voltage;
a gate driving circuit, electrically connected to the voltage level shifter, for providing a plurality of gate signals according to the preliminary driving signal; and
a pixel array unit, electrically connected to gate driving circuit, for displaying images according to the gate signals;
wherein the high reference voltage is changed from the first high reference voltage to the second high reference voltage when a predetermined time has elapsed since initially powering the liquid crystal display.

2. The liquid crystal display of claim 1, wherein the voltage selector comprises:
a first switch, electrically connected to the control unit, the reference voltage generator and the voltage level shifter, for outputting the first high reference voltage to become the high reference voltage according to the control signal; and
a second switch, electrically connected to the control unit, the reference voltage generator and the voltage level shifter, for outputting the second high reference voltage to become the high reference voltage according to the control signal;
wherein the first switch is turned on for outputting the first high reference voltage to become the high reference voltage when the control signal holds a first state, and the second switch is turned on for outputting the second high reference voltage to become the high reference voltage when the control signal holds a second state.

3. The liquid crystal display of claim 2, wherein the control signal is switched from the first state to the second state when the predetermined time has elapsed since initially powering the liquid crystal display.

4. The liquid crystal display of claim 2, wherein the control signal is switched from the first state to the second state when a predetermined number of frames have been displayed since initially powering the liquid crystal display, the predetermined time being a period required for displaying the predetermined number of frames.

5. The liquid crystal display of claim 1, wherein the control unit comprises:
a timer for generating a timing signal through performing a timing operation automatically after the liquid crystal display is powered;
wherein the control unit provides the control signal according to the timing signal.

6. The liquid crystal display of claim 1, wherein the timing controller comprises:
a frame counter, electrically connected to the control unit, for generating a counting signal through performing a frame counting operation automatically after the liquid crystal display is powered;
wherein the control unit provides the control signal according to the counting signal.

7. The liquid crystal display of claim 1, wherein the gate driving circuit and the pixel array unit are integrated in a display panel.

8. The liquid crystal display of claim 1, further comprising:
a source driving circuit, electrically connected to the pixel array unit, for providing a plurality of data signals required for displaying images;
wherein the pixel array unit performs an operation of writing the data signals under control of the gate signals.

9. A liquid crystal display comprising:
a reference voltage generator for providing a high reference voltage and a low reference voltage based on a power voltage;
an adjustable power module, electrically connected to the reference voltage generator, for providing the power voltage, wherein the power voltage is changed from a first voltage to a second voltage less than the first voltage when a predetermined time has elapsed since initially powering the liquid crystal display;
a timing controller for providing a scan control signal;
a voltage level shifter, electrically connected to the timing controller and the reference voltage generator, for generating a preliminary driving signal according to the scan control signal, the high reference voltage and the low reference voltage;
a gate driving circuit, electrically connected to the voltage level shifter, for providing a plurality of gate signals according to the preliminary driving signal; and
a pixel array unit, electrically connected to gate driving circuit, for displaying images according to the gate signals.

10. The liquid crystal display of claim 9, wherein the adjustable power module comprises:
a control unit for providing a control signal; and
a power voltage generation unit, electrically connected to the control unit and the reference voltage generator, for generating the power voltage according to the control signal.

11. The liquid crystal display of claim 10, wherein the control signal is switched from a first state to a second state for changing the power voltage from the first voltage to the second voltage when the predetermined time has elapsed since initially powering the liquid crystal display.

12. The liquid crystal display of claim 10, wherein the control signal is switched from a first state to a second state for changing the power voltage from the first voltage to the second voltage when a predetermined number of frames have been displayed since initially powering the liquid crystal display, the predetermined time being a period required for displaying the predetermined number of frames.

13. The liquid crystal display of claim 10, wherein the control unit comprises:
a timer for generating a timing signal through performing a timing operation automatically after the liquid crystal display is powered;
wherein the control unit provides the control signal according to the timing signal.

14. The liquid crystal display of claim 10, wherein the timing controller comprises:
a frame counter, electrically connected to the control unit, for generating a counting signal through performing a frame counting operation automatically after the liquid crystal display is powered;
wherein the control unit provides the control signal according to the counting signal.

15. The liquid crystal display of claim 9, wherein the gate driving circuit and the pixel array unit are integrated in a display panel.

16. The liquid crystal display of claim 9, further comprising:
a source driving circuit, electrically connected to the pixel array unit, for providing a plurality of data signals required for displaying images;
wherein the pixel array unit performs an operation of writing the data signals under control of the gate signals.

17. A method of driving a liquid crystal display, the method comprising:
providing a high reference voltage and a low reference voltage during a predetermined time after initially powering the liquid crystal display, wherein the high reference voltage is a first high reference voltage;
driving a pixel array unit of the liquid crystal display for displaying images according to the first high reference voltage and the low reference voltage during the predetermined time;
changing the high reference voltage from the first high reference voltage to a second high reference voltage less than the first high reference voltage after the predetermined time; and
driving the pixel array unit for displaying images according to the second high reference voltage and the low reference voltage after the predetermined time.

18. The method of claim 17, wherein the predetermined time is a period required for displaying a predetermined number of frames by the liquid crystal display.

19. The method of claim 17, wherein changing the high reference voltage from the first high reference voltage to the second high reference voltage less than the first high reference voltage is changing a power voltage from a first voltage to a second voltage less than the first voltage for changing the high reference voltage from the first high reference voltage to the second high reference voltage less than the first high reference voltage.
